(19) United States
(12) Patent Application Publication
(10) Pub. No.: US 2024/0406788 A1
(43) Pub. Date: Dec. 5, 2024

(54) UE POWER SAVING WITH TRAFFIC CLASSIFICATION AND UE ASSISTANCE

(71) Applicant: Samsung Electronics Co., Ltd., Suwon-si (KR)

(72) Inventors: Anum Ali, Frisco, TX (US); Yuqiang Heng, Plano, TX (US); Vutha Va, Plano, TX (US); Priyabrata Parida, Dallas, TX (US); Boon Loong Ng, Plano, TX (US)

(21) Appl. No.: 18/534,447

(22) Filed: Dec. 8, 2023

Related U.S. Application Data
(60) Provisional application No. 63/471,179, filed on Jun. 5, 2023.

(51) Int. Cl. H04W 28/02; H04B 7/06; H04W 28/08; H04W 76/20

(52) U.S. Cl. CPC H04W 28/0268; H04B 7/063; H04B 7/0632; H04W 28/0942; H04W 76/20

(57) ABSTRACT

A user equipment (UE) includes a transceiver. The transceiver is configured to receive and transmit traffic, over a time step, via a wireless network. The UE further includes a processor. The processor is configured to determine a plurality of statistical features for the traffic received and transmitted over the time step, classify the traffic received and transmitted over the time step into a traffic class based on the statistical features and a traffic classification operation, determine a link condition, and select, based on the traffic class and the link condition, a set of preferred radio frequency (RF) parameters from a table. The transceiver is further configured to transmit UE assistance information (UAI) to the wireless network corresponding with the selected set of preferred RF parameters.

### CROSS-REFERENCE TO RELATED APPLICATION(S) AND CLAIM OF PRIORITY

This application claims priority under 35 U.S.C. § 119 (e) to U.S. Provisional Patent Application No. 63/471,179 filed on Jun. 5, 2023. The above-identified provisional patent application is hereby incorporated by reference in its entirety.

### TECHNICAL FIELD

This disclosure relates generally to wireless networks. More specifically, this disclosure relates to apparatuses and methods for user equipment (UE) power saving with traffic classification and UE assistance.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are being implemented at a rapid pace. However, such improvements often require higher power consumption by end user devices, and new techniques for increased battery life and/or reduced power usage are desirable.

### SUMMARY

This disclosure provides apparatuses and methods for UE power saving with traffic classification and UE assistance.

In one embodiment, a UE is provided. The UE includes a transceiver. The transceiver is configured to receive and transmit traffic, over a time step, via a wireless network. The UE further includes a processor. The processor is configured to determine a plurality of statistical features for the traffic received and transmitted over the time step, classify the traffic received and transmitted over the time step into a traffic class based on the statistical features and a traffic classification operation, determine a link condition, and select, based on the traffic class and the link condition, a set of preferred radio frequency (RF) parameters from a table. The transceiver is further configured to transmit UE assistance information (UAI) to the wireless network corresponding with the selected set of preferred RF parameters.

In another embodiment, a method of operating a UE is provided. The method includes receiving and transmitting traffic, over a time step, via a wireless network, determining a plurality of statistical features for the traffic received and transmitted over the time step, classifying the traffic received and transmitted over the time step into a traffic class based on the statistical features and a traffic classification operation, and determining a link condition. The method further includes selecting, based on the traffic class and the link condition, a set of preferred RF parameters from a table, and transmitting UAI to the wireless network corresponding with the selected set of preferred RF parameters.

In yet another embodiment, a non-transitory computer readable medium is provided. The non-transitory computer readable medium embodies a computer program including program code that, when executed by a processor of a device, causes the device to receive and transmit traffic, over a time step, via a wireless network, determine a plurality of statistical features for the traffic received and transmitted over the time step, classify the traffic received and transmitted over the time step into a traffic class based on the statistical features and a traffic classification operation, and determine a link condition. The computer program further includes program code that, when executed by the processor of the device, causes the device to select, based on the traffic class and the link condition, a set of preferred RF parameters from a table, and transmit user equipment UAI to the wireless network corresponding with the selected set of preferred RF parameters.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example a CDRX operation according to various embodiments of this disclosure;

FIG. 5 illustrates an example of BWP switching and MIMO layers adaptation according to various embodiments of this disclosure;

FIG. 6 illustrates an example UAI framework according to embodiments of the present disclosure;

FIG. 7 illustrates an example method for UAI-based UE power saving according to embodiments of the present disclosure;

FIG. 8 illustrates an example of 5G specific traffic classes according to various embodiments of this disclosure;

FIG. 9 illustrates an example of feature generation according to various embodiments of this disclosure;

FIG. 10 illustrates an example trained tree from an XGBoost model according to various embodiments of this disclosure; and

FIG. 11 illustrates a method for UE power saving with traffic classification and UE assistance according to embodiments of the present disclosure.

### DETAILED DESCRIPTION

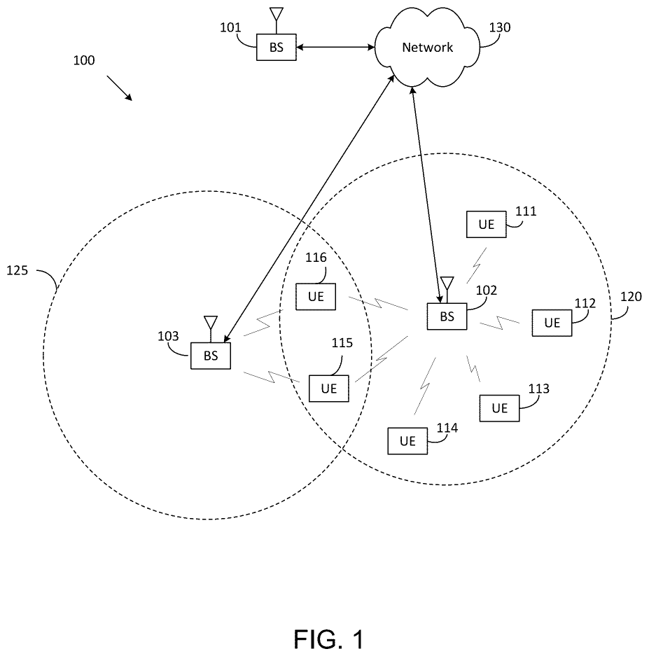

FIGS. 1 through 11, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for UE power saving with traffic classification and UE assistance. In certain embodiments, one or more of the gNBs 101-103 includes circuitry, programing, or a combination thereof, to support UE power saving with traffic classification and UE assistance in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

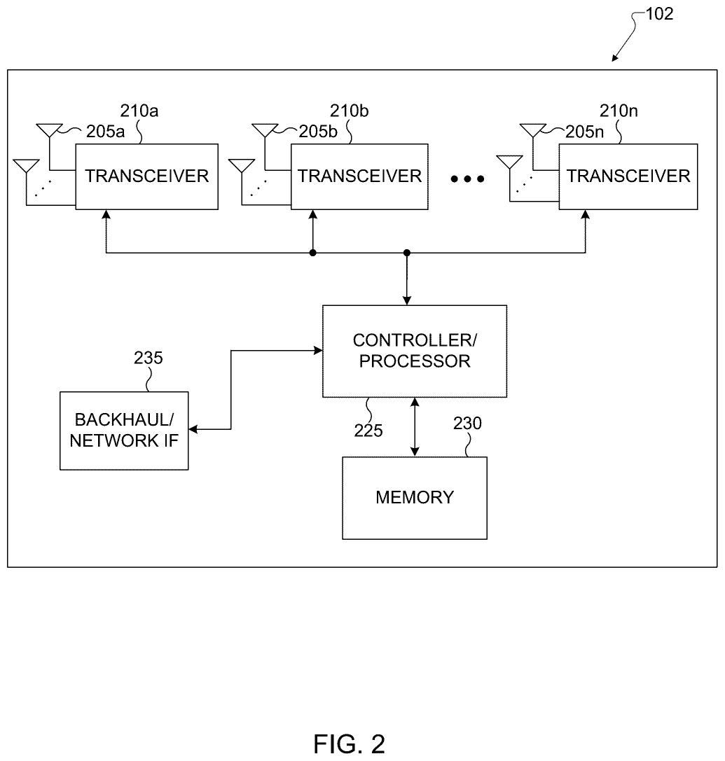

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235. Controller/processor 225 may also be referred to as an application processor (AP), a communications processor (CP), etc.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support UE power saving with traffic classification and UE assistance as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

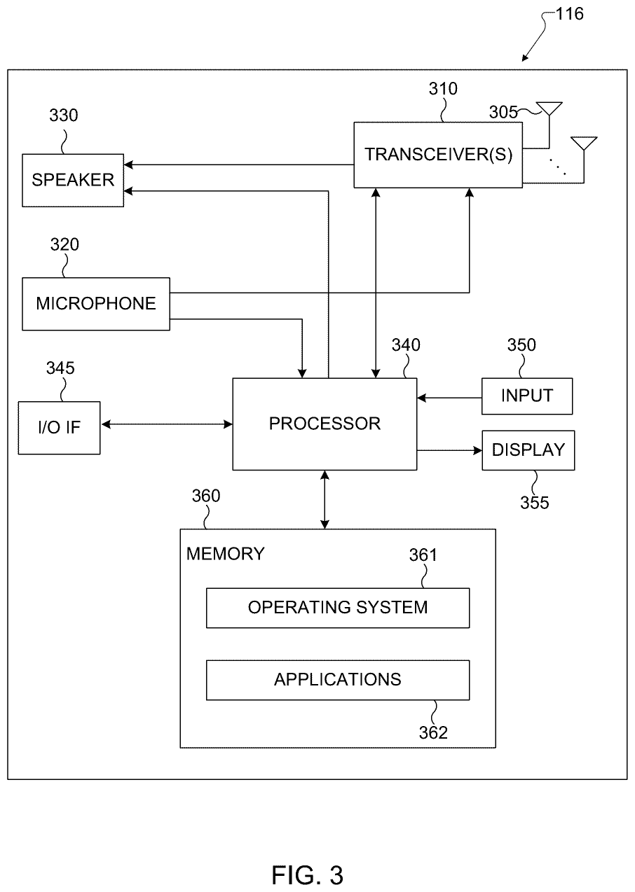

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362. Processor 340 may also be referred to as an application processor (AP), a communications processor (CP), etc.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for UE power saving with traffic classification and UE assistance as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

The fifth generation (5G) of cellular communication, i.e., 5G new radio (NR) provides high throughput compared to fourth generation (4G) long term evolution (LTE). This high throughput is achieved using a large bandwidth (BW) and a large number of antennas, but this results in high power consumption. Techniques to reduce the 5G UE power consumption have been investigated extensively by the 3rd generation partnership project (3GPP). However, most of the power-saving strategies are totally under the control of the network (NW). The UE assistance information (UAI) framework previously described herein is one exception that permits the user equipment (UE) to influence its power consumption by indicating the UE's preference for multiple radio frequency (RF) parameters to the network (NW).

In the present disclosure, the UAI framework is used for 5G UE power saving. Specifically, the UE determines the current traffic type and subsequently shares the UE's preference on the RF parameters with the NW. The RF parameters are chosen to maximize power saving while ensuring that the quality of service (QOS) requirement of the current traffic type is met. In the examples of the present disclosure, a latency requirement of the current traffic type is used as the QoS requirement, as well as a throughput requirement.

Several 5G UE power-saving techniques have been investigated by 3GPP. These techniques include cross-slot scheduling, bandwidth part (BWP) adaptation, discontinuous reception (DRX), radio resource control (RRC)-inactive mode, wakeup signal (WUS), two-step RACH, UE assistance information (UAI), etc. The UAI framework introduced in Release 16 allows a 5G UE to indicate its preference on several RF parameters to the network (NW), and as a result, influence its power consumption.

Traffic classification and subsequent determination of power saving parameters at the UE has been studied in the past for WiFi using target wake time (TWT). The TWT is a power-saving mechanism that enables a station (STA) an access point (AP) to negotiate when the STA will be awake to send and receive data. The wake period is adaptively configured based on the traffic type and its corresponding latency. In LTE, a single-bit power preference indication (PPI) was introduced. Using PPI, the UE could indicate its desire to enter a power-saving state to the NW. Essentially, the low power consumption state was a connected mode discontinuous reception (CDRX) configuration that permitted the UE to sleep for a longer duration. The CDRX parameters for the low power consumption state were determined by the NW.

The power consumption of a smartphone is due to multiple components, including the screen, processor, modem, and RF front end. Herein a brief introduction is provided to the UE power-saving strategies that are most relevant to the present disclosure.

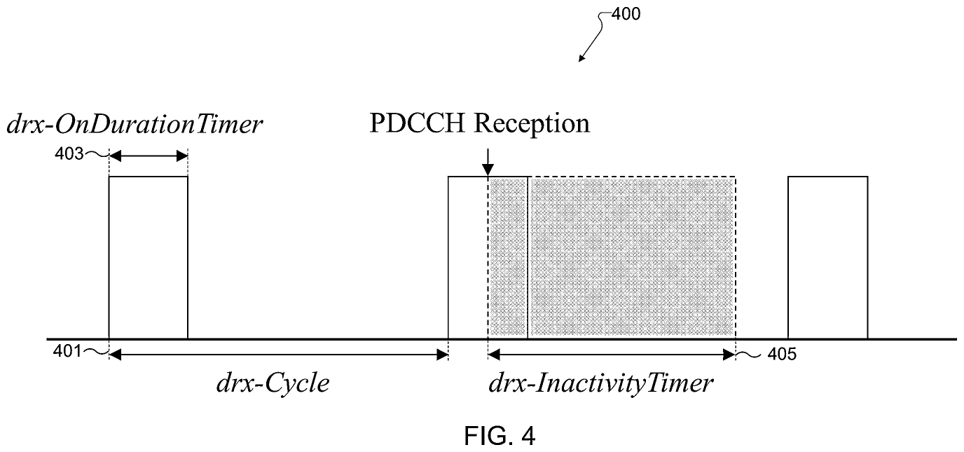

CDRX enables an RRC-connected UE to wake up periodically at predetermined intervals to monitor the physical downlink control channel (PDCCH). If there is no PDCCH, the UE enters a power-saving sleep state. CDRX is configured by the NW using RRC-configuration through three main parameters, namely drx-Cycle, drx-onDurationTimer, and drx-Inactivity Timer as illustrated in FIG. 4.

FIG. 4 illustrates an example of a CDRX operation 400 according to various embodiments of this disclosure. The embodiment of a CDRX operation in FIG. 4 is for illustration only. Other embodiments of a CDRX operation could be used without departing from the scope of this disclosure.

As illustrated in FIG. 4, the drx-Cycle parameter defines a periodicity 401 with which the UE wakes up. Once the UE wakes up, the UE monitors PDCCH during a time 403 defined by the drx-onDuration Timer parameter. If a PDCCH is not detected during the time 403 defined by drx-onDurationTimer, the UE goes back to sleep. Otherwise, the UE extends the DRX active time by a time 405 defined by the drx-Inactivity Timer parameter.

Although FIG. 4 illustrates one example of CDRX operation 400, various changes may be made to FIG. 4. For example, the length of drx-Cycle, drx-onDurationTimer, and drx-Inactivity Timer may vary, etc. according to particular needs.

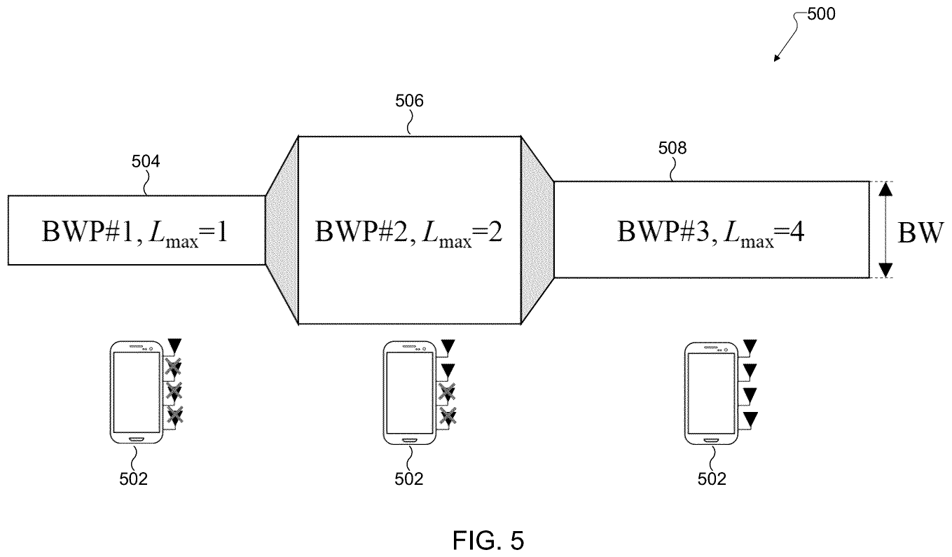

5G/NR supports several hundreds of MHz of bandwidth to provide high throughput. Operation with such bandwidth requires large Fourier transforms and a high-performance analog-to-digital converter (ADC). Since the UE does not require a high throughput at all times, the concept of bandwidth part (BWP) was introduced in 5G/NR. BWP refers to a portion of the system BW, over which the UE is configured to transmit and receive signals. The UE can be configured with up to 4 UL and DL BWPs, but only one BWP is active at any given time. The NW can switch the UE's active BWP among the configured BWPs via downlink control information (DCI). The switching of the BWP among multiple BWPs is illustrated in FIG. 5.

FIG. 5 illustrates an example of BWP switching and MIMO layers adaptation 500 according to various embodiments of this disclosure. The embodiment of BWP switching MIMO layers adaptation in FIG. 5 is for illustration only. Other embodiments of BWP switching MIMO layers adaptation could be used without departing from the scope of this disclosure.

In the example of FIG. 5, a BWP configuration of a UE 502 is depicted over a particular time span. During a portion of the time span 504, UE 502 is configured to transmit and receive signals over BWP #1. During a portion of the time span 506, the configuration of UE 502 is switched so that UE 502 is configured to transmit and receive signals over BWP #2. Finally, during a portion of the time span 508, the configuration of UE 502 is switched so that UE 502 is configured to transmit and receive signals over BWP #3.

Using a large number of antennas at the UE enables high throughput applications but incurs high power consumption. Hence, through antenna adaptation, the UE can save power when high throughput is not required. While using fewer antennas, the power savings come from turning off the RF components as well as skipping the channel estimation for the unused antennas. The maximum number of MIMO layers Lₘₐₓ can be adapted under the BWP framework. Specifically, multiple BWPs can be configured, each with a different Lₘₐₓ as illustrated in FIG. 5.

In the example of FIG. 5, a MIMO layer configuration of UE 502 is depicted over a particular time span. During the portion of the time span 504, UE 502 is configured with Lₘₐₓ=1 so that UE 502 may transmit and receive signals over only a single MIMO layer. During the portion of the time span 506, the configuration of UE 502 is switched to Lₘₐₓ=2 so that UE 502 may transmit and receive signals over two MIMO layers. Finally, during the portion of the time span 508, the configuration of UE 502 is switched to Lₘₐₓ=4 so that UE 502 may transmit and receive signals over four MIMO layers.

Although FIG. 5 illustrates one example of BWP switching MIMO layers adaptation 500, various changes may be made to FIG. 5. For example, the number of BWPs may vary, the MIMO layer configuration may vary, etc. according to particular needs.

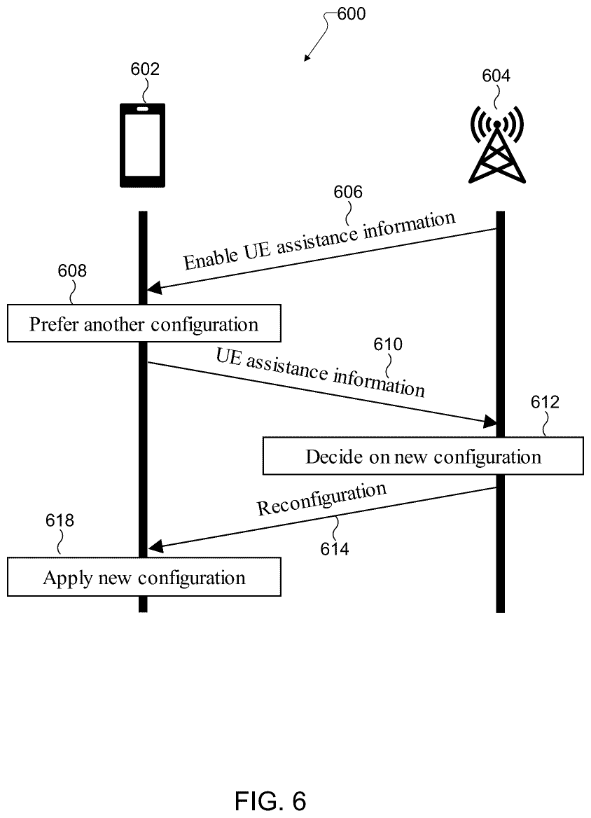

By utilizing the UE assistance information (UAI) framework introduced in Release 16, a UE can influence its own configuration by informing the NW about the UE's configuration preferences as illustrated in FIG. 6. For example, UAI messages can be sent for indicating preferred RF parameters for saving power, reducing overheating, and indicating preferred RRC state among others.

FIG. 6 illustrates an example UAI framework 600 according to embodiments of the present disclosure. An embodiment of the UAI framework illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a UAI framework may be used without departing from the scope of this disclosure.

As illustrated in FIG. 6, a UAI operation is performed between a UE 602 and a BS 604. The operation of UAI framework 600 begins at step 606. At step 606, BS 604 transmits a message enabling UE assistance information from UE 602. At step 608, UE 602 determines that a different configuration from the present configuration of UE 602 is preferred. At step 610, UE 602 transmits UE assistance information to BS 604. At step 612, BS 604 determines a new configuration for UE 602 based on the UE assistance information received in step 610. At step 614, BS 604 transmits the new configuration to UE 602. Finally, at step 618, UE 602 applies the new configuration received in step 614.

Although FIG. 6 illustrates one example UAI framework 600, various changes may be made to FIG. 6. For example, while shown as a series of steps, various steps in FIG. 6 could overlap, occur in parallel, occur in a different order, or occur any number of times.

The packet delay budget (PDB) requirements for various services are described in the 3GPP standard. A subset of these requirements is provided in Table 2. Specifically, the delay budget of Table 2 is defined in terms of the 98th percentile. That is to say, for guaranteed bit rate (GBR) applications, 98 percent of all the packets shall not experience a delay exceeding the PDB, whereas, for non-guaranteed bit rate (NGBR) applications, the 98th percentile requirement applies to uncongested scenarios. In addition to the PDB, a fixed core network (CN) PDB is also defined. The access network (AN)-PDB can then be obtained as the difference between the PDB and the CN-PDB. The AN-PDB thus obtained, however, is relatively generous (see Table 2). To evaluate with relatively stringent requirements, 50% of the AN-PDB given by the 3GPP is assumed for evaluations described in the present disclosure. This stringent 5G-AN-PDB requirement used in the evaluations described herein is also given in Table 2. The same PDB is assumed for the UL and the DL packets.

TABLE 1
Latency requirements of several traffic classes as defined in the 3GPP standard.

| | | | | | 5G-AN PDB |
|---|---|---|---|---|---|
| | | | | | used in |
| | PDB | CN-PDB | GBR/ | 5G-AN PDB | evaluation |
| Example Services | (ms) | (ms) | NGBR | (ms) | (ms) |
| Conversational Voice | 100 | 20 | GBR | 80 | 40 |
| Conversational Video (Live Streaming) | 150 | 20 | GBR | 130 | 65 |
| Real-Time Gaming | 50 | 20 | GBR | 30 | 15 |
| Non-Conversational Video (Buffered | 300 | 20 | GBR | 280 | 140 |
| Streaming) | | | | | |
| Video (Buffered Streaming) TCP-based | 300 | 20 | NGBR | 280 | 140 |
| (e.g., www, e-mail, chat, ftp, p2p | | | | | |
| file sharing, progressive video, etc.) | | | | | |
| Voice, Video (Live Streaming), | 100 | 20 | NGBR | 80 | 40 |
| Interactive Gaming | | | | | |

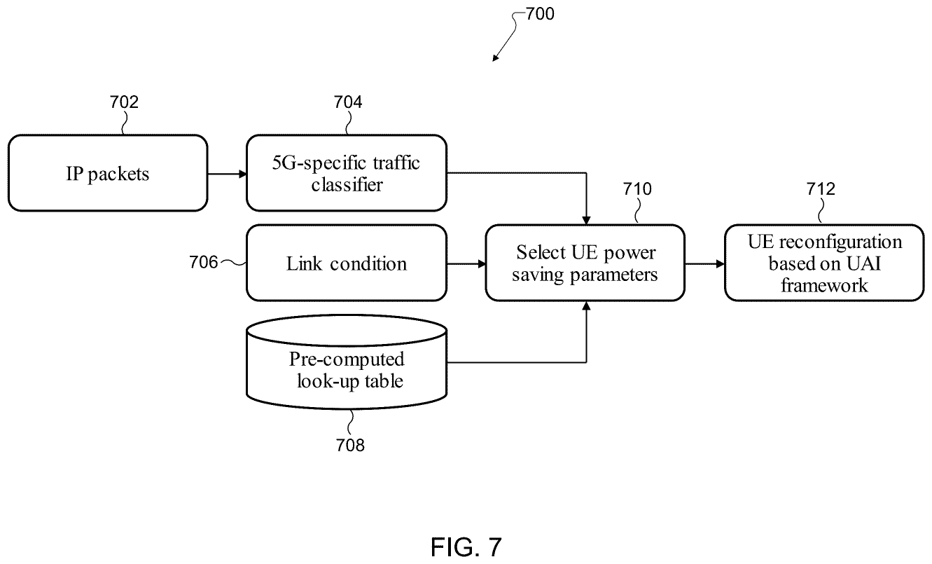

According to embodiments of the present disclosure, a UE proposes RF parameters through the UAI framework that can meet the QoS requirement of the current traffic while minimizing the power consumption of the UE as illustrated in FIG. 7.

FIG. 7 illustrates an example method 700 for UAI-based UE power saving according to embodiments of the present disclosure. An embodiment of the method for UAI-based UE power saving illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a method for UAI-based UE power saving may be used without departing from the scope of this disclosure.

In the example of FIG. 7, IP packets 702 are fed to a 5G specific traffic classifier 704 which classifies the current traffic into one of multiple classes. At block 710, the link condition 706, e.g., CQI/RI, in addition to the predicted class from traffic classifier 704, are input to a module (e.g., a software routine, a dedicated hardware module, etc.) that predicts the suitable power-saving parameters (i.e., RF parameters) that can meet the QoS requirements of the currently predicted class in the current link condition, while maximizing the power savings. This module can be based on a pre-computed look-up table 708, in which case the module takes the link condition 706, and the traffic class from traffic classifier 704 and looks up the table to select UE power saving parameters. The selected UE power saving parameters may be referred to as preferred RF parameters. These preferred RF parameters are then shared with the NW, which re-configures the UE using RRC-reconfiguration at block 712, similar as described regarding FIG. 6.

The current traffic type is used at block 710 to determine the preferred RF parameters to be shared with the NW at block 712. Traffic classification is essential to various traffic engineering tasks and is a relatively well-studied problem. Several state-of-the-art strategies extract features from the packets and use machine learning (ML) for traffic classification. In contrast, traffic classifier 704 utilizes 5G parameter choices. This is to say that different applications are grouped, and classes are defined based on what 5G parameters, i.e., BW, MIMO layers, and connected mode DRX (CDRX) parameters can satisfy the requirement of those applications. This is different from other traffic classification methods, which are not specific to 5G and do not consider traffic groupings based on BW, MIMO layers, and CDRX requirements.

In the example of FIG. 7 disclosure, the UAI framework for 5G introduced in Release 16 is used in block 712 similar as described regarding FIG. 6. This framework permits the UE to indicate the UE's own preferred CDRX parameters, and others, e.g., BW, and the maximum number of MIMO layers, etc. These may be referred to as preferred RF parameters. The UE's indication of its preference for multiple RF parameters provides finer control for the UE to influence its power consumption. A subset of parameters for which the UE can indicate its preference includes:
The drx-Cycle and drx-Inactivity Timer similar as described regarding FIG. 4.
The maximum BW Bₘₐₓ (UE preference can only be to reduce the BW).
The maximum number of MIMO layers Lₘₐₓ for the DL and/or UL operation (UE preference can only be to reduce the number of layers) similar as described regarding FIG. 5.

How often the UE can send its preferred RF parameters is controlled by prohibit timers. Specifically, there is a prohibit timer associated to each of the above power-saving mechanisms, i.e., CDRX, BW, and Layers. Once the UE indicates its preference to the NW, it is at the NW's discretion to grant the UE its preference. In the examples of the present disclosure, however, it is assumed that the NW grants UE's preferred RF parameters. The UE is reconfigured with the preferred RF parameters through RRC-reconfiguration.

Although FIG. 7 illustrates one example method 700 for UAI-based UE power saving, various changes may be made to FIG. 7. For example, while shown as a series of steps, various steps in FIG. 7 could overlap, occur in parallel, occur in a different order, or occur any number of times.

As previously described herein regarding FIG. 7, a 5G specific traffic classifier 704 classifies current traffic into one of multiple classes. However, a training operation for 5G specific traffic classifier 704 should be performed to ensure accurate traffic classification. For example, 5G specific traffic classifier 704 may be trained in an offline training operation. In one embodiment, for offline training of 5G specific traffic classifier 704, the data for several real-time (RT) and nonreal-time (NRT) applications can be collected. As an example, among the RT applications, the data for WhatsApp audio and video calls, Messenger audio and video calls, and an interactive game Among Us can be collected. For the NRT applications, the data for web browsing on Chrome, YouTube, and Amazon Prime Video streaming can be collected.

In one embodiment, during online operation of 5G specific traffic classifier 704, the IP packets can be fetched directly from the UE's transport layers. For example, tools like TCPdump can provide access to the IP packets at the UE.

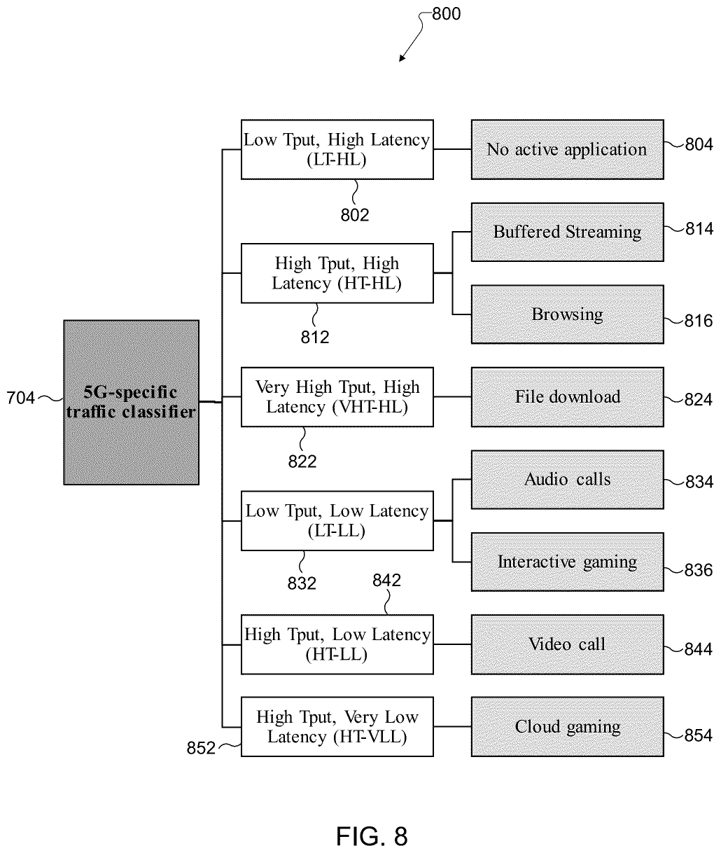

To develop a traffic classifier, traffic classes should be defined. For example, the traffic can be classified in terms of the traffic's throughput requirement and latency tolerance. For instance, low throughput can be considered anything below 100 kbps, while high throughput can be considered in the 100 kbs to 2.5 mbps, and very high throughput anything larger than 2.5 mbps. Similarly, a high latency requirement can be considered to be 300 ms, a low latency requirement can be considered 150 ms, and a very low latency requirement can be considered 30 ms. In this example, all of the latency requirements are 98th percentile. For throughput any measure can be used, e.g., median. Based on these considerations, the examples of the present disclosure classify traffic into the six categories illustrated in FIG. 8.

FIG. 8 illustrates an example 800 of 5G specific traffic classes according to various embodiments of this disclosure. The embodiment of 5G specific traffic classes in FIG. 8 is for illustration only. Other embodiments of 5G specific traffic classes could be used without departing from the scope of this disclosure.

In the example of FIG. 8, 5G specific traffic classifier 704 classifies traffic into the following categories:
Low Throughput, High Latency (LT-HL) 802
High Throughput, High Latency ((HT-HL) 812
Very High Throughput, High Latency (VHT-HL) 822
Low Throughput, Low Latency (LT-LL) 832
High Throughput, Low Latency (HT-LL) 842
High Throughput, Very Low Latency (HT-VLL) 852

Different applications may correspond with different traffic classes. For instance, in the example of FIG. 8, no active application (804) corresponds with the class LT-HL 802. Similarly, buffered streaming 814 and browsing 816 correspond with the class HT-HL 812. Other correspondences of the example of FIG. 8 are as follows:
File download 824 with VHT-HL 822
Audio calls 834 and interactive gaming 836 with LT-LL 832
Video call 844 with HT-LL 842
Cloud gaming 854 with HT-VLL 852

In the example of FIG. 8, the combinations of latency and throughput are not exhaustive, since some combinations may not be feasible. For example, it may not be possible to support an extremely low latency and very high throughput application by the wireless network. Note that the classification of traffic based on throughput and latency is not specific to 5G. The rationale of the present disclosure for calling these classes 5G specific stems from the way optimal RF parameters of these classes are grouped. In actuality, the RF parameters (BW, MIMO layers, and CDRX) do not impact the throughput or latency exclusively, rather each parameter impacts both the throughput and latency. But generally, it is expected for the throughput performance to be primarily impacted by the BW and MIMO layers, and the latency performance to be primarily impacted by the CDRX parameters.

With this understanding, the classification in terms of the throughput and latency becomes 5G specific, as the configuration of BW and MIMO Layers can be used to control throughput performance, and the configuration of CDRX can be used to control latency performance. This is in contrast to WiFi, where only the target wake time (TWT)—a concept similar to CDRX for the device to doze off periodically-parameters are controlled, and hence separation in terms of parameters influencing the throughput or latency is not possible.

Although FIG. 8 illustrates one example 800 of 5G specific traffic classes, various changes may be made to FIG. 8. For example, the number of classes may vary, the types of classes may vary, etc. according to particular needs.

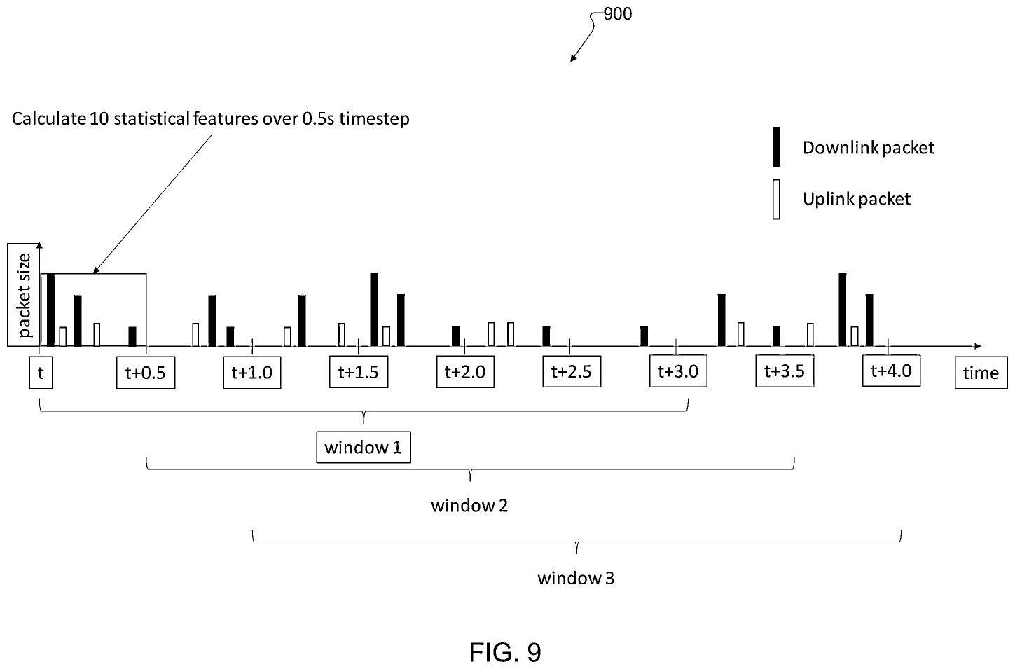

In one embodiment of 5G specific traffic classifier 704, for traffic classification, a ML model is offline trained with ten statistical features. These features are computed over a 0.5 sec interval, called a time step. The features are described as follows:
UL packet inter-arrival time (2 features): The maximum and average time difference between the arrival of UL packets. If no packet is observed, both maximum and average are set to be the time-step
Packet counts (2 features): The number of UL and DL packets. If no packets are observed, the packet counts are set to 0.
UL and DL packet sizes (6 features): The maximum, minimum, and average packet sizes for both UL and DL. If no packets are observed, all packet sizes are set to 0. In this embodiment, the traffic classifier is trained assuming a moving window over the features. Specifically, features are collected from six time-steps, i.e., a three second period, and the classifier is trained with updated features every time step, similar as depicted in the feature calculation timing diagram illustrated in FIG. 9.

FIG. 9 illustrates an example 900 of feature generation according to various embodiments of this disclosure. The embodiment of feature classification in FIG. 9 is for illustration only. Other embodiments of feature generation could be used without departing from the scope of this disclosure.

In the example of FIG. 9, the ten statistical features described herein are collected from a six time-step moving window. Each time step is 0.5 seconds. For example, it can be seen that window 1 corresponds to time steps t through t+3.0, window 2 corresponds with time steps t+0.5 through t+3.5, and window 3 corresponds with time steps t+1.0 through t+4.0. While not shown, it should be understood that additional windows would correspond with later time steps. For example, a fourth window would correspond with time steps t+1.5 through t+4.5 (not shown).

Although FIG. 9 illustrates one example 900 of feature generation, various changes may be made to FIG. 9. For example, the size of the time steps may vary, the feature collection window may vary, etc. according to particular needs.

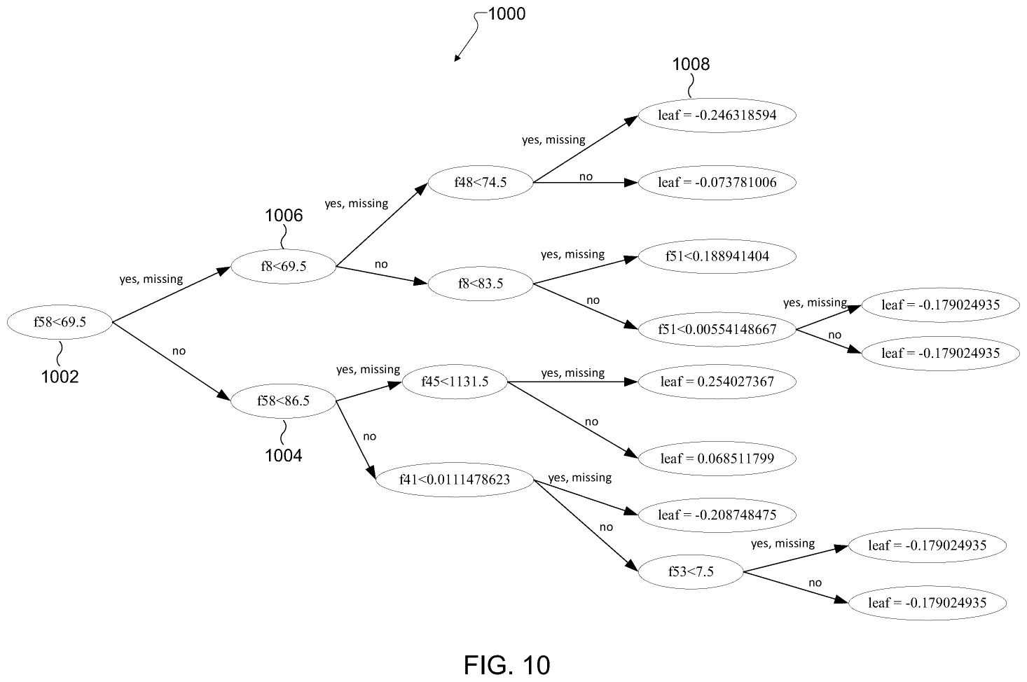

In one embodiment, 5G specific traffic classifier 704 utilizes XGBoost to implement the ML model for the traffic classifier. XGBoost is a software library that provides a regularizing gradient boosting framework. XGBoost works by combining a number of weak learners (in the case of XGBoost-trees) to form a strong learner. In one embodiment, the XGBoost ML model is trained according to the ten statistical features as described herein regarding FIG. 9. During the training of XGBoost, a new tree is added—in every iteration—that predicts the residuals or errors of previously added trees. The prediction of the newly added tree is then combined with the previous trees to make the final prediction. In one embodiment, the model includes 100 estimators, each estimator has a maximum tree depth of six, and a learning rate of 0.3. These hyper-parameters of the model are found empirically, i.e., by testing a variety of parameters and using the parameters that give the best performance as final choice. One estimator/tree of a trained model as described above is illustrated in FIG. 10.

FIG. 10 illustrates an example trained tree 1000 from an XGBoost model according to various embodiments of this disclosure. The embodiment of trained tree 1000 FIG. 10 is for illustration only. Other embodiments of trained trees from an XGBoost model could be used without departing from the scope of this disclosure.

In the example of FIG. 10, since there are ten statistical features, each calculated over 0.5 seconds and collected over three seconds, the ten features are collected six times. So, the total number of features can be considered to be sixty from the perspective of the XGBoost. The decision tree starts at node 1002 by checking if the 58th features is less than 69.5. The value 69.5 is learnt by the model. If the value is greater than 69.5, then at node 1004 the model checks if it is less than 86.5. If, however, the values is less than 69.5 or the value is missing, at node 1006 the tree checks if the 8th feature is less than 69.5. The decision making continues until a leaf (e.g., leaf 1008) is reached. The leaf node and the value of the leaf can be understood better in the context of binary classification. For a classification tree with two classes {0,1}, the value of the leaf node represents the raw score for class 1. The raw score can be converted to a probability score by using a logistic function.

Although FIG. 10 illustrates one example trained tree 1000 from an XGBoost model, various changes may be made to FIG. 10. For example, the number of features may vary, the feature values may vary, etc. according to particular needs.

In one embodiment, during online operation of 5G specific traffic classifier 704, all ten statistical features are computed and used to classify traffic. The UE records the time stamps of the packets as they arrive as well as the packet size, which is extracted from the unencrypted packet header. Every 0.5 seconds, the UE collects the number of packets, size of the packets and the arrival time stamps in the previous 0.5 seconds—in both the uplink and the downlink—and computes the ten features constituting a feature vector. A Berkley Packet Filter can be used to compute these packets statistics. It's also possible to directly interact with the network lane of the phone operating system (OS) to extract these packet features. The feature vector is input into a queue that stores the most recent 6 feature vectors, i.e., features computed in the previous three seconds. All six feature vectors are concatenated to be used as the input to the ML model. In one embodiment, 5G specific traffic classifier 704 can be implemented in an application processor (AP) comprised by the UE.

As previously described herein regarding FIG. 7, the link condition 706, in addition to the predicted class from traffic classifier 704, are input to the module that predicts the suitable power-saving parameters (i.e., at block 710). For example, as part of the normal cellular operation the UE obtains signal quality metrics like reference signal received power (RSRP), reference signal received quality (RSRP), and signal to interference plus noise ratio (SINR) etc. These signal quality metrics are then converted to the channel quality indicator (CQI) and rank indicator (RI)—if multiple antennas are used. The CQI and RI are then fed back to the gNB using channel state information (CSI) measurement reports. The gNB uses the CQI/RI received from the UE for scheduling and resource allocation etc. As such the link condition information is available at the UE's communication processor. In one embodiment, this information is shared with an application processor (AP) comprised by the UE where the UE power saving solution described herein may be implemented.

As previously described herein regarding FIG. 7, the module that predicts the suitable power-saving parameters (i.e., at block 710) can be based on a pre-computed look-up table (i.e., block 708). The table is pre-computed based on an average power consumption and a 98th percentile latency of each combination of a plurality of available RF parameter combinations according to an associated channel quality indicator (CQI) and an associated rank indicator (RI). In one embodiment, the lookup table construction is done offline. The optimal RF parameters are found experimentally per CQI/RI. The rationale for finding optimal RF parameters per CQI/RI is that optimal RF parameters can substantially differ in good and poor link conditions. To find the optimal RF parameters, an exhaustive search is conducted over all the RF parameter combinations given in Table 2. To understand how the values are selected to search for each RF parameter, note that the power saving of the power saving strategy described herein was compared with parameters that were observed in a commercial band NW. In the present disclosure, these observed parameters are referred to as “NW-configured” and these observed parameters are also given in Table 2. Since a goal of the present disclosure is reduced power consumption, a search is conducted for parameters that are likely to result in less power consumption than the NW-configured parameters. As such, a search is conducted for UL BW, DL BW, UL MIMO layers, DL MIMO layers, and CDRX inactivity timers that are less than the NW-configured parameters. For the CDRX cycle, both higher and lower values compared to the NW-configured cycle are identified. This is because of the intertwined impact of the inactivity timer and the cycle on power consumption. Specifically, a smaller cycle may consume less power than the NW-configured cycle, when it is used with an inactivity timer that is smaller compared to the NW-configured inactivity timer. Finally, given a CDRX cycle, a search is only performed for inactivity timer values that are less than the cycle.

For each trace, parameter combination, and CQI/RI, the average power consumption and 98th percentile latency are obtained from the simulation. The latency requirement for each category is defined to be the minimum across its applications given in Table 2. For each category and CQI/RI, the optimal RF parameters are chosen to minimize the average power consumption across traces under the constraint that the 98th percentile latency does not exceed the requirement for any trace in both UL and the DL. If multiple RF parameters have the same power consumption, the power parameters that minimize the DL and UL latency are selected. If the latency constraint cannot be met with any RF parameter combination, then the parameters that yield the minimum 98th percentile latency are selected. Finally, if multiple parameter combinations achieve the same latency, the parameters with the least power consumption are selected. The aforementioned search procedure produces the look-up tables (LUTs) that are given in Table 3 to Table 6. It should be understood that even though the optimal RF parameters are found per CQI/RI, separate LUTs are generated for the cell-center and cell edge cases since the CQI-to-MCS mapping is different for both cases. Further, the LUTs of the present disclosure do not include the LTHT case and the VHT-HL case. This is because the lowest UL and DL bandwidth, the smallest number of MIMO layers, longest CDRX cycle duration, and shortest CDRX inactivity timer are chosen for the LT-HT case regardless of CQI/RI. Similarly, the highest bandwidth and the largest number of MIMO layers are used for VHT-HL for all CQI/RI values. Due to the consistent nature of the traffic in VHT-HL, the CDRX parameters are not highly consequential. Therefore, the shortest CDRX cycle is used, and inactivity timer is set to be the same as the CDRX cycle.

The order of the optimal RF parameters as given in tables 2-6 is DL BW (MHZ), UL BW (MHz), DL MIMO layers, CDRX cycle (ms), and CDRX inactivity timer (ms). The HT-HL category requires higher bandwidth in both the DL and the UL as well as a larger number of MIMO layers compared to the LT-LL and HT-LL categories. A longer CDRX cycle, however, can sometimes be used for the HT-HL applications to save power. The parameters for LT-LL and HT-LL applications are relatively similar, particularly for mid to high CQI values. This is because the parameters that can satisfy the latency requirement for all the applications in a given category are chosen.

In one embodiment, the look up tables are stored in the application processor (AP) of the device, where the power management solution described herein may also reside.

TABLE 2
The NW-configured and the exhaustively
searched values of RF parameters.

| Parameter | NW-configured | Searched values |
|---|---|---|
| DL Bandwidth (MHz) | 60 | 20, 40, 60 |
| UL Bandwidth (MHz) | 60 | 20, 40, 60 |
| DL MIMO Layers | 4 | 1, 2, 4 |
| UL MIMO Layers | 1 | 1 |
| CDRX cycle (ms) | 160 | 40, 80, 160, 256 |
| CDRX inactivity timer (ms) | 100 | 20, 40, 80, 100 |

TABLE 3
Look-up table for cell center, RI = 0

| CQI, RI | LT-LL | HT-LL | HT-HL |
|---|---|---|---|
| 1, 0 | 40, 40, 1, 40, 20 | 20, 40, 1, 40, 20 | 60, 40, 1, 80, 20 |
| 2, 0 | 40, 20, 1, 40, 20 | 20, 20, 1, 40, 20 | 60, 60, 1, 40, 20 |
| 3, 0 | 20, 20, 1, 40, 20 | 20, 20, 1, 40, 20 | 60, 60, 1, 40, 20 |
| 4, 0 | 20, 20, 1, 40, 20 | 20, 20, 1, 40, 20 | 60, 40, 1, 40, 20 |
| 5, 0 | 20, 20, 1, 40, 20 | 20, 20, 1, 40, 20 | 60, 20, 1, 40, 20 |
| 6, 0 | 20, 20, 1, 40, 20 | 20, 20, 1, 40, 20 | 60, 20, 1, 40, 20 |
| 7, 0 | 20, 20, 1, 40, 20 | 20, 20, 1, 40, 20 | 60, 60, 1, 40, 20 |
| 8, 0 | 20, 20, 1, 40, 20 | 20, 20, 1, 40, 20 | 60, 40, 1, 40, 20 |
| 9, 0 | 20, 20, 1, 40, 20 | 20, 20, 1, 40, 20 | 60, 40, 1, 40, 20 |
| 10, 0 | 20, 20, 1, 40, 20 | 20, 20, 1, 40, 20 | 60, 60, 1, 40, 20 |
| 11, 0 | 20, 20, 1, 40, 20 | 20, 20, 1, 40, 20 | 60, 60, 1, 40, 20 |
| 12, 0 | 20, 20, 1, 40, 20 | 20, 20, 1, 40, 20 | 60, 60, 1, 40, 20 |
| 13, 0 | 20, 20, 1, 40, 20 | 20, 20, 1, 40, 20 | 60, 40, 1, 40, 20 |
| 14, 0 | 20, 20, 1, 40, 20 | 20, 20, 1, 40, 20 | 60, 20, 1, 80, 20 |
| 15, 0 | 20, 20, 1, 40, 20 | 20, 20, 1, 40, 20 | 60, 20, 1, 160, 20 |

TABLE 4
Look-up table for cell center, RI = 1

| CQI, RI | LT-LL | HT-LL | HT-HL |
|---|---|---|---|
| 1, 1 | 40, 40, 1, 40, 20 | 20, 40, 1, 40, 20 | 60, 40, 2, 40, 20 |
| 2, 1 | 40, 20, 1, 40, 20 | 20, 20, 1, 40, 20 | 60, 60, 2, 40, 20 |
| 3, 1 | 20, 20, 1, 40, 20 | 20, 20, 1, 40, 20 | 60, 20, 2, 40, 20 |
| 4, 1 | 20, 20, 1, 40, 20 | 20, 20, 1, 40, 20 | 60, 20, 2, 40, 20 |
| 5, 1 | 20, 20, 1, 40, 20 | 20, 20, 1, 40, 20 | 60, 60, 2, 40, 20 |
| 6, 1 | 20, 20, 1, 40, 20 | 20, 20, 1, 40, 20 | 60, 40, 2, 40, 20 |
| 7, 1 | 20, 20, 1, 40, 20 | 20, 20, 1, 40, 20 | 60, 60, 2, 40, 20 |
| 8, 1 | 20, 20, 1, 40, 20 | 20, 20, 1, 40, 20 | 60, 20, 2, 160, 20 |
| 9, 1 | 20, 20, 1, 40, 20 | 20, 20, 1, 40, 20 | 60, 20, 2, 160, 20 |
| 10, 1 | 20, 20, 1, 40, 20 | 20, 20, 1, 40, 20 | 60, 20, 2, 160, 20 |
| 11, 1 | 20, 20, 1, 40, 20 | 20, 20, 1, 40, 20 | 60, 20, 2, 160, 20 |
| 12, 1 | 20, 20, 1, 40, 20 | 20, 20, 1, 40, 20 | 40, 20, 2, 160, 20 |
| 13, 1 | 20, 20, 1, 40, 20 | 20, 20, 1, 40, 20 | 40, 20, 2, 160, 20 |
| 14, 1 | 20, 20, 1, 40, 20 | 20, 20, 1, 40, 20 | 40, 20, 2, 160, 20 |
| 15, 1 | 20, 20, 1, 40, 20 | 20, 20, 1, 40, 20 | 40, 20, 2, 160, 20 |

TABLE 5
Look-up table for cell edge, RI = 0

| CQI, RI | LT-LL | HT-LL | HT-HL |
|---|---|---|---|
| 1, 0 | 40, 40, 1, 40, 20 | 20, 40, 1, 40, 20 | 60, 40, 1, 80, 20 |
| 2, 0 | 40, 20, 1, 40, 20 | 20, 20, 1, 40, 20 | 60, 40, 1, 40, 20 |
| 3, 0 | 20, 20, 1, 40, 20 | 20, 20, 1, 40, 20 | 60, 60, 1, 40, 20 |
| 4, 0 | 20, 20, 1, 40, 20 | 20, 20, 1, 40, 20 | 60, 60, 1, 40, 20 |
| 5, 0 | 20, 20, 1, 40, 20 | 20, 20, 1, 40, 20 | 60, 40, 1, 40, 20 |
| 6, 0 | 20, 20, 1, 40, 20 | 20, 20, 1, 40, 20 | 60, 20, 1, 40, 20 |
| 7, 0 | 20, 20, 1, 40, 20 | 20, 20, 1, 40, 20 | 60, 20, 1, 40, 20 |
| 8, 0 | 20, 20, 1, 40, 20 | 20, 20, 1, 40, 20 | 60, 40, 1, 40, 20 |
| 9, 0 | 20, 20, 1, 40, 20 | 20, 20, 1, 40, 20 | 60, 60, 1, 40, 20 |
| 10, 0 | 20, 20, 1, 40, 20 | 20, 20, 1, 40, 20 | 60, 40, 1, 40, 20 |
| 11, 0 | 20, 20, 1, 40, 20 | 20, 20, 1, 40, 20 | 60, 20, 1, 40, 20 |
| 12, 0 | 20, 20, 1, 40, 20 | 20, 20, 1, 40, 20 | 60, 60, 1, 40, 20 |
| 13, 0 | 20, 20, 1, 40, 20 | 20, 20, 1, 40, 20 | 60, 20, 1, 40, 20 |
| 14, 0 | 20, 20, 1, 40, 20 | 20, 20, 1, 40, 20 | 60, 20, 1, 40, 20 |
| 15, 0 | 20, 20, 1, 40, 20 | 20, 20, 1, 40, 20 | 60, 20, 1, 40, 20 |

TABLE 6
Look-up table for cell edge, RI = 1

| CQI, RI | LT-LL | HT-LL | HT-HL |
|---|---|---|---|
| 1, 1 | 60, 40, 1, 40, 20 | 20, 40, 1, 40, 20 | 60, 60, 2, 40, 20 |
| 2, 1 | 40, 40, 1, 40, 20 | 20, 40, 1, 40, 20 | 60, 60, 2, 40, 20 |
| 3, 1 | 40, 20, 1, 40, 20 | 20, 20, 1, 40, 20 | 60, 40, 2, 40, 20 |
| 4, 1 | 40, 20, 1, 40, 20 | 20, 20, 1, 40, 20 | 60, 60, 2, 40, 20 |
| 5, 1 | 20, 20, 1, 40, 20 | 20, 20, 1, 40, 20 | 60, 20, 2, 40, 20 |
| 6, 1 | 20, 20, 1, 40, 20 | 20, 20, 1, 40, 20 | 60, 20, 2, 40, 20 |
| 7, 1 | 20, 20, 1, 40, 20 | 20, 20, 1, 40, 20 | 60, 60, 2, 40, 20 |
| 8, 1 | 20, 20, 1, 40, 20 | 20, 20, 1, 40, 20 | 60, 60, 2, 40, 20 |
| 9, 1 | 20, 20, 1, 40, 20 | 20, 20, 1, 40, 20 | 60, 40, 2, 40, 20 |
| 10, 1 | 20, 20, 1, 40, 20 | 20, 20, 1, 40, 20 | 60, 60, 2, 40, 20 |
| 11, 1 | 20, 20, 1, 40, 20 | 20, 20, 1, 40, 20 | 60, 40, 2, 40, 20 |
| 12, 1 | 20, 20, 1, 40, 20 | 20, 20, 1, 40, 20 | 60, 20, 2, 80, 20 |
| 13, 1 | 20, 20, 1, 40, 20 | 20, 20, 1, 40, 20 | 60, 20, 2, 160, 20 |
| 14, 1 | 20, 20, 1, 40, 20 | 20, 20, 1, 40, 20 | 60, 20, 2, 160, 20 |
| 15, 1 | 20, 20, 1, 40, 20 | 20, 20, 1, 40, 20 | 60, 20, 2, 160, 20 |

Selection of the optimal RF parameters is an online process. Given the classification results of the traffic classifier, the link condition (i.e., CQI/RI) at the UE, and look up tables constructed offline, the UE may select the optimal RF parameters simply by finding the matching entry from the look up tables. The 5G traffic classifier, as well as the LUTs can reside in an application process layer comprised by UE. The CQI/RI may be shared by the a communication processor (CP) with the application process layer. The process of finding out the optimal RF parameters from the LUT based on CQI/RI and the classifier results is carried out at the application process layer. Finally, the determined optimal parameters are shared with the CP, at which point they may be transmitted to the network as preferred RF parameters via UAI.

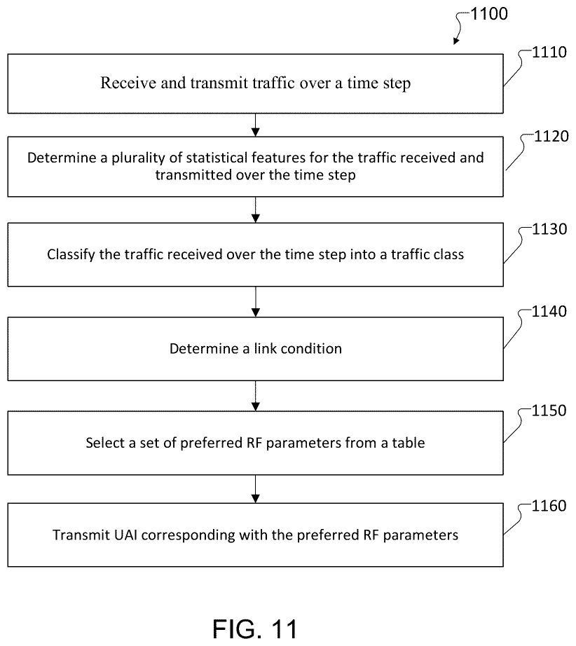

FIG. 11 illustrates a method 1100 for UE power saving with traffic classification and UE assistance according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method 1100 for UE power saving with traffic classification and UE assistance may be used without departing from the scope of this disclosure.

As illustrated in FIG. 11, the method 1100 begins at step 1110. At step 1110, a UE receives and transmits traffic, over a time step, via a wireless network. At step 1120, the UE determines a plurality of statistical features for the traffic received and transmitted over the time step. At step 1130, the UE classifies the traffic received over the time step into a traffic class. The classification may be based on the statistical features and a traffic classification operation. At step 1140, the UE determines a link condition. At step 1150, the UE selects a set of preferred RF parameters from a table. The selection may be based on the traffic class and the link condition. Finally, at step 1160, the UE transmits UAI to the wireless network corresponding with the selected set of preferred RF parameters.

Although FIG. 11 illustrates one example of a method 1100 for UE power saving with traffic classification and UE assistance, various changes may be made to FIG. 11. For example, while shown as a series of steps, various steps in FIG. 11 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive and transmit traffic, over a time step, via a wireless network; and
a processor operably coupled to the transceiver, the processor configured to:
determine a plurality of statistical features for the traffic received and transmitted over the time step;
classify the traffic received and transmitted over the time step into a traffic class based on the statistical features and a traffic classification operation;
determine a link condition; and
select, based on the traffic class and the link condition, a set of preferred radio frequency (RF) parameters from a table;
wherein the transceiver is further configured to transmit UE assistance information (UAI) to the wireless network corresponding with the selected set of preferred RF parameters.

2. The UE of claim 1, wherein:
the transceiver is further configured to receive, from the wireless network, in response to the UAI, a radio resource control (RRC)-reconfiguration to reconfigure the UE according to the selected set of preferred RF parameters; and
the processor is further configured to reconfigure the UE according to the RRC-reconfiguration.

3. The UE of claim 1, wherein the traffic classification operation is performed based on a 5G specific traffic classifier that classifies the traffic based on throughput and latency.

4. The UE of claim 3, wherein:
the traffic classifier is a machine learning (ML) model that has been trained with an offline training operation based on the plurality of statistical features; and
the plurality of statistical features includes:
maximum uplink (UL) packet inter-arrival time;
average UL packet inter-arrival time;
UL packet count;
downlink (DL) packet count;
maximum UL packet size;
minimum UL packet size;
average UL packet size;
maximum DL packet size;
minimum DL packet size; and
average DL packet size.

5. The UE of claim 4, wherein the ML model is an XGBoost model, and the XGBoost model is trained over a plurality of time steps and a moving window over the plurality of time steps.

6. The UE of claim 1, wherein the link condition is determined based on a channel quality indicator (CQI) and a rank indicator (RI).

7. The UE of claim 6, wherein:
the transceiver is further configured to receive at least one signal quality metric; and
the processor is further configured to determine the CQI and the RI based on the at least one signal quality metric.

8. The UE of claim 1, wherein:
the table is pre-computed based on an average power consumption and a 98th percentile latency of each combination of a plurality of available RF parameter combinations according to an associated channel quality indicator (CQI) and an associated rank indicator (RI); and
the preferred RF parameters are selected to minimize an average power consumption of the UE.

9. The UE of claim 1, wherein the preferred RF parameters are related to at least one of:
a downlink (DL) bandwidth;
an uplink (UL) bandwidth;
a number of DL MIMO layers;
a number of UL MIMO layers;
a connected mode discontinuous reception (CDRX) cycle; and
a CDRX inactivity timer.

10. A method of operating a user equipment (UE), the method comprising:
receiving and transmitting traffic, over a time step, via a wireless network;
determining a plurality of statistical features for the traffic received and transmitted over the time step;
classifying the traffic received over the time step into a traffic class based on the statistical features and a traffic classification operation;
determining a link condition;
selecting, based on the traffic class and the link condition, a set of preferred radio frequency (RF) parameters from a table; and
transmitting UE assistance information (UAI) to the wireless network corresponding with the selected set of preferred RF parameters.

11. The method of claim 10, further comprising:
receiving, from the wireless network, in response to the UAI, a radio resource control (RRC)-reconfiguration to reconfigure the UE according to the selected set of preferred RF parameters; and
reconfiguring the UE according to the RRC-reconfiguration.

12. The method of claim 10, wherein the traffic classification operation is performed based on a 5G specific traffic classifier that classifies the traffic based on throughput and latency.

13. The method of claim 12, wherein:
the traffic classifier is a machine learning (ML) model that has been trained with an offline training operation based on the plurality of statistical features; and
the plurality of statistical features includes:
maximum uplink (UL) packet inter-arrival time;
average UL packet inter-arrival time;
UL packet count;
downlink (DL) packet count;
maximum UL packet size;
minimum UL packet size;
average UL packet size;
maximum DL packet size;
minimum DL packet size; and
average DL packet size.

14. The method of claim 13, wherein the ML model is an XGBoost model, and the XGBoost model is trained over a plurality of time steps and a moving window over the plurality of time steps.

15. The method of claim 10, wherein the link condition is determined based on a channel quality indicator (CQI) and a rank indicator (RI).

16. The method of claim 15, further comprising:
receiving at least one signal quality metric; and
determining the CQI and the RI based on the at least one signal quality metric.

17. The method claim 10, wherein:
the table is pre-computed based on an average power consumption and a 98th percentile latency of each combination of a plurality of available RF parameter combinations according to an associated channel quality indicator (CQI) and an associated rank indicator (RI); and
the preferred RF parameters are selected to minimize an average power consumption of the UE.

18. The method of claim 10, wherein the preferred RF parameters are related to at least one of:
a downlink (DL) bandwidth;
an uplink (UL) bandwidth;
a number of DL MIMO layers;
a number of UL MIMO layers;
a connected mode discontinuous reception (CDRX) cycle; and
a CDRX inactivity timer.

19. A non-transitory computer readable medium embodying a computer program, the computer program comprising program code that, when executed by a processor of a device, causes the device to:
receive and transmit traffic, over a time step, via a wireless network;
determine a plurality of statistical features for the traffic received and transmitted over the time step;
classify the traffic received and transmitted over the time step into a traffic class based on the statistical features and a traffic classification operation;
determine a link condition;
select, based on the traffic class and the link condition, a set of preferred radio frequency (RF) parameters from a table; and
transmit user equipment (UE) assistance information (UAI) to the wireless network corresponding with the selected set of preferred RF parameters.

20. The non-transitory computer readable medium of claim 19, wherein the computer program further comprises program code that, when executed by the processor of the device causes the device to:
receive, from the wireless network, in response to the UAI, a radio resource control (RRC)-reconfiguration to reconfigure the UE according to the selected set of preferred RF parameters; and
reconfigure the UE according to the RRC-reconfiguration.
